(19) United States
(12) Patent Application Publication
(10) Pub. No.: US 2026/0074243 A1
(43) Pub. Date: Mar. 12, 2026

(54) LOW-TEMPERATURE RANKINE CYCLE SYSTEM FOR RECOVERING WASTE HEAT FROM A FUEL CELL SYSTEM

(71) Applicant: GM GLOBAL TECHNOLOGY OPERATIONS LLC, Detroit, MI (US)

(72) Inventors: Gary CAI, Rochester, MI (US); Brian PODCZERVINSKI, West Bloomfield, MI (US); Amer FARHAT, Dearborn, MI (US)

(21) Appl. No.: 18/829,106

(22) Filed: Sep. 9, 2024

(51) Int. Cl. H01M 8/04029; F01D 15/02; F01D 15/10; H01M 8/04007

(52) U.S. Cl. CPC H01M 8/04029; F01D 15/02; F01D 15/10; H01M 8/04074; H01M 2250/20; H01M 2250/407

(57) ABSTRACT

A fuel cell system includes F fuel cell stacks, where F is an integer greater than or equal to one. A coolant system includes liquid coolant in fluid communication with the F fuel cell stacks. A waste heat recovery system includes a turbine, a generator rotated by the turbine, a condenser in fluid communication with an outlet of the turbine, a pump fluidly coupled to an outlet of the condenser, and a heat exchanger in fluid communication with the coolant system, an inlet of the turbine and an outlet of the pump and configured to exchange heat between the liquid coolant and a working fluid to expand the working fluid supplied to the inlet of the turbine.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to fuel cell systems, and more particularly to a heat recovery system for a fuel cell system.

A fuel cell system includes an electrochemical cell that converts chemical energy of molecular hydrogen and oxygen into electricity through a pair of redox reactions. The fuel cell systems include a proton exchange membrane (PEM) arranged between a cathode electrode and an anode electrode. During operation, the fuel cell system generates heat and needs to be cooled. A cooling system circulates liquid coolant that cools components of the fuel cell system. A radiator cools the liquid coolant.

### SUMMARY

A fuel cell system includes F fuel cell stacks, where F is an integer greater than or equal to one. A coolant system includes liquid coolant in fluid communication with the F fuel cell stacks. A waste heat recovery system includes a turbine, a generator rotated by the turbine, a condenser in fluid communication with an outlet of the turbine, a pump fluidly coupled to an outlet of the condenser, and a heat exchanger in fluid communication with the coolant system, an inlet of the turbine and an outlet of the pump and configured to exchange heat between the liquid coolant and a working fluid to expand the working fluid supplied to the inlet of the turbine.

In other features, a sensor configured to sense an operating parameter of the working fluid. A controller is configured to control the pump to adjust a flow rate of the working fluid flowing through the heat exchanger in response to the sensed operating parameter. The operating parameter is selected from a group consisting of temperature, pressure, flow rate, and combinations thereof. The operating parameter is sensed between at least one of the turbine and the heat exchanger, the turbine and the condenser, the condenser and the pump, and the pump and the heat exchanger.

In other features, the heat exchanger includes tubing configured to receive the working fluid. The condenser exchanges heat between the working fluid and air. The condenser exchanges heat between the working fluid and a liquid.

A vehicle comprising the fuel cell system.

A fuel cell system includes F fuel cell stacks, where F is an integer greater than zero. A coolant system includes liquid coolant in fluid communication with the F fuel cell stacks. A waste heat recovery system includes a turbine receiving a working fluid after expansion, a generator rotated by the turbine, a pump, and a heat exchanger in fluid communication with the coolant system, an inlet of the turbine and an outlet of the pump and configured to exchange heat between the liquid coolant and a working fluid to expand the working fluid supplied to the inlet of the turbine. A condenser/radiator includes a radiator portion configured to receive liquid coolant from the coolant system and to exchange heat between the liquid coolant and a first fluid, a condenser portion configured to exchange heat between the working fluid from the waste heat recovery system and a second fluid, and a separating wall arranged between the radiator portion and the condenser portion.

In other features, the second fluid includes air. The second fluid includes a liquid. The radiator portion includes first tubing configured to receive the liquid coolant. The condenser portion includes second tubing configured to receive the working fluid. A sensor is configured to sense an operating parameter of the working fluid. A controller is configured to adjust a flow rate of the working fluid flowing through the condenser portion in response to the sensed operating parameter. The operating parameter is selected from a group consisting of temperature, pressure, flow rate, and combinations thereof. The operating parameter is sensed between at least one of the turbine and the heat exchanger, the turbine and the condenser portion, the condenser portion and the pump, and the pump and the heat exchanger.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIGS. 1 to 3B are functional block diagrams of examples of power generating systems including a fuel cell system and a low-temperature Rankine cycle system (LORCS) that recovers heat from the fuel cell systems according to the present disclosure;

FIG. 4A is a functional block diagram of an example of a fuel cell system, a low-temperature Rankine cycle system (LORCS) that recovers heat from the fuel cell system, and a combined condenser/radiator according to the present disclosure; and

FIG. 4B is a side view of a combined condenser/radiator according to the present disclosure.

In the drawings, reference numbers may be reused to identify similar and/or identical elements.

### DETAILED DESCRIPTION

The present disclosure relates to a waste heat recovery system for a power generating system including a fuel cell system (FCS). The FCS may produce power for stationary applications or mobile applications (such as a vehicle). The FCS includes F fuel cell stacks, where F is an integer greater than zero (e.g., F=10). In some examples, the fuel cell stacks include a proton exchange membrane (PEM) arranged between a cathode electrode and an anode electrode. The waste heat recovery system includes a low-temperature Rankine cycle system (LORCS) that recovers waste heat from a coolant system circulating liquid coolant that is heated by the F fuel cells stacks of the FCS.

The waste heat is converted by the waste heat recovery system into electrical energy to improve overall system efficiency. Rather than rejecting the waste heat from the FCS to atmosphere, the waste heat from the liquid coolant is used to expand a working fluid in a heat exchanger. The expanded working fluid rotates a turbine and a generator. Since the waste heat recovery system absorbs heat from the liquid coolant, the waste heat recovery system can be used to reduce the amount of heat rejection that the vehicle or application needs to provide. In other words, the LORCS allows a smaller sized radiator to be used.

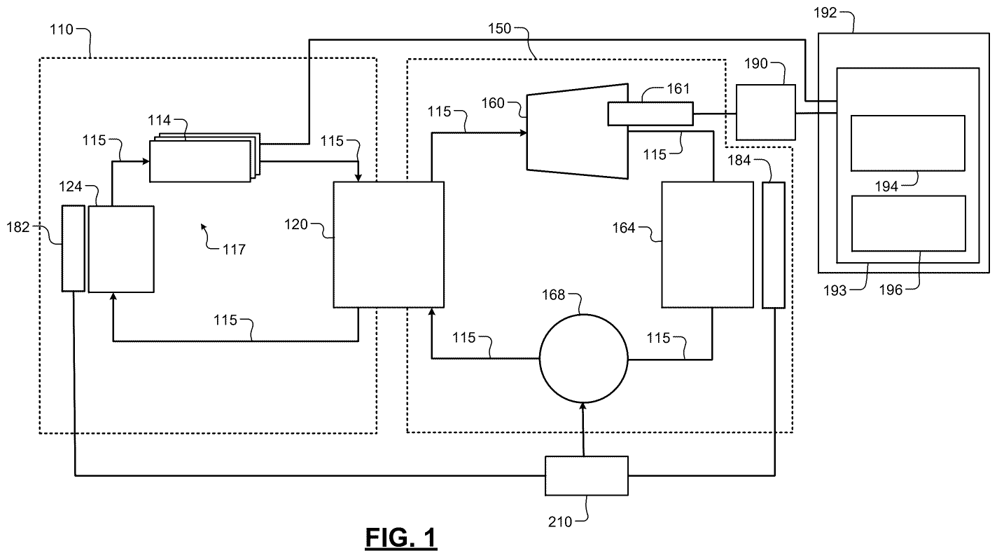

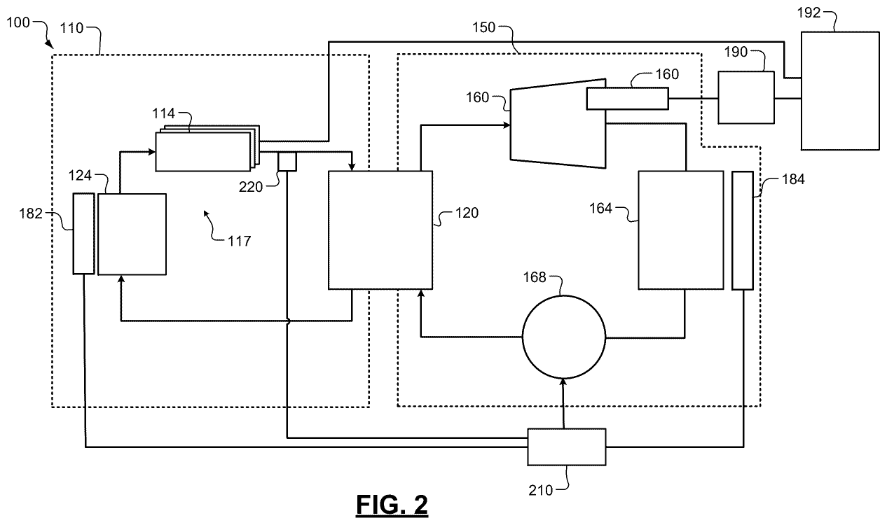

Referring now to FIG. 1, a fuel cell system 110 includes F fuel cell stacks 114, where F is an integer greater than zero. A coolant system 117 flows liquid coolant through conduit 115, to the F fuel cell stacks 114, to a heat exchanger 120, and to a radiator 124. In some examples, the coolant system 117 includes a pump (not shown). For example, the pump can be located between adjacent components of the FCS such as before or after the heat exchanger 120.

The liquid coolant from the coolant system 117 absorbs heat generated by the F fuel cell stacks 114. In some examples, the liquid coolant is heated by the F fuel cell stacks 114. The liquid coolant that is heated by the F fuel cell stacks 114 flows through conduit 115 to a first inlet of a heat exchanger 120. The heat exchanger 120 also includes a second inlet receiving a working fluid such as a refrigerant. The heat exchanger 120 transfers heat from the liquid coolant to the working fluid causing the working fluid to expand.

A first outlet of the heat exchanger 120 circulates the liquid coolant (after heat exchange with the working fluid) to an inlet of a radiator 124 for further cooling. In some examples, a fan 182 selectively flows air across the radiator 124 to increase cooling. An outlet of the radiator 124 supplies the liquid coolant to the F fuel cell stacks 114 (which heats the liquid coolant and the heat exchange process repeats).

The heat exchanger 120 fluidly communicates with a waste heat recovery system 150 such as a low-temperature Rankine cycle system (LORCS). The waste heat recovery system 150 also circulates the working fluid to the heat exchanger 120. The heat exchanger 120 expands the working fluid (e.g., to a vapor state). The expanded working fluid is delivered to an inlet of a turbine 160 causing the turbine 160 to rotate. Rotation of the turbine 160 also rotates a generator 161 to produce power that is supplied to a power converter 190 and a high voltage bus 192.

The expanded working fluid at an outlet of the turbine 160 is fed to an inlet of a condenser 164. The condenser 164 condenses the working fluid (e.g., to a liquid state). In some examples, a fan 184 selectively flows air across the condenser 164 to increase cooling efficiency. An outlet of the condenser 164 is fluidly coupled to an inlet of a pump 168. The pump 168 increases the pressure of the working fluid supplied to a second inlet of the heat exchanger 120. The working fluid passes through the heat exchanger 120 and is heated by the liquid coolant to a vapor state.

The heat exchanger 120 is located after the F fuel cell stacks 114 where the liquid coolant has the highest thermal energy. Rather than rejecting the heat to atmosphere, the heat is used to generate power, which improves the efficiency of the power generating system.

The electrical energy generated by the turbine 160 rotating the generator 161 is fed to the power converter 190 (e.g., an AC/DC converter, a DC/AC converter, and/or DC/DC converter) and then to the high voltage bus 192. The high voltage bus 192 includes high voltage DC storage 193 including a battery pack 194 and/or a supercapacitor 196.

Referring now to FIG. 2, one or more operating parameters of the liquid coolant and/or working fluid (such as temperature, pressure, and/or flow rate) can be sensed at various locations and used to adjust operation. For example, a controller 210 in FIG. 2 communicates with a temperature sensor 220 sensing a temperature of the liquid coolant exiting the F fuel cell stacks 114. The controller 210 varies flow of the working fluid by adjusting operation of the pump 168 in response to the sensed temperature. For example, the controller 210 increases the flow rate of the working fluid (e.g., by increasing pump speed) in response to increased temperature of the liquid coolant exiting the F fuel cell stacks 114. The controller 210 decreases the flow rate of the working fluid (e.g., by decreasing pump speed) in response to decreased temperature of the liquid coolant exiting the F fuel cell stacks 114.

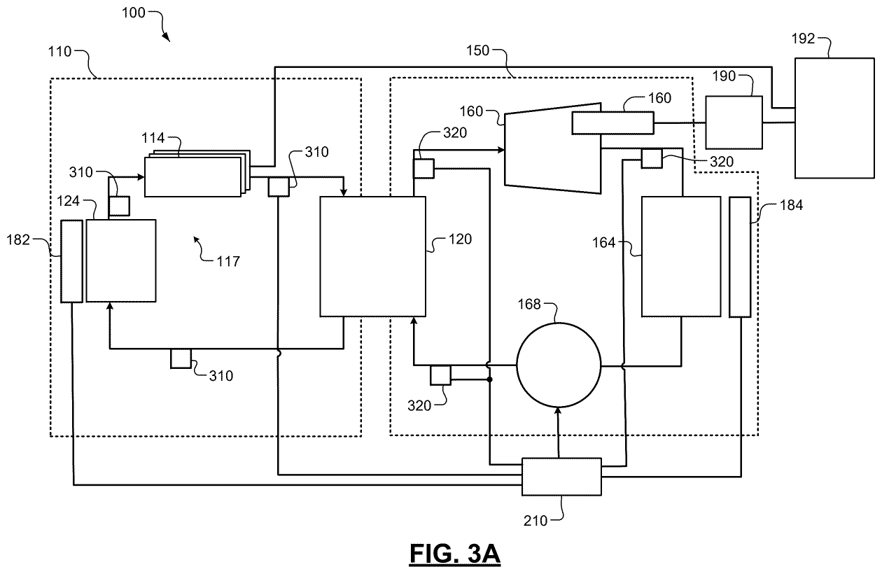

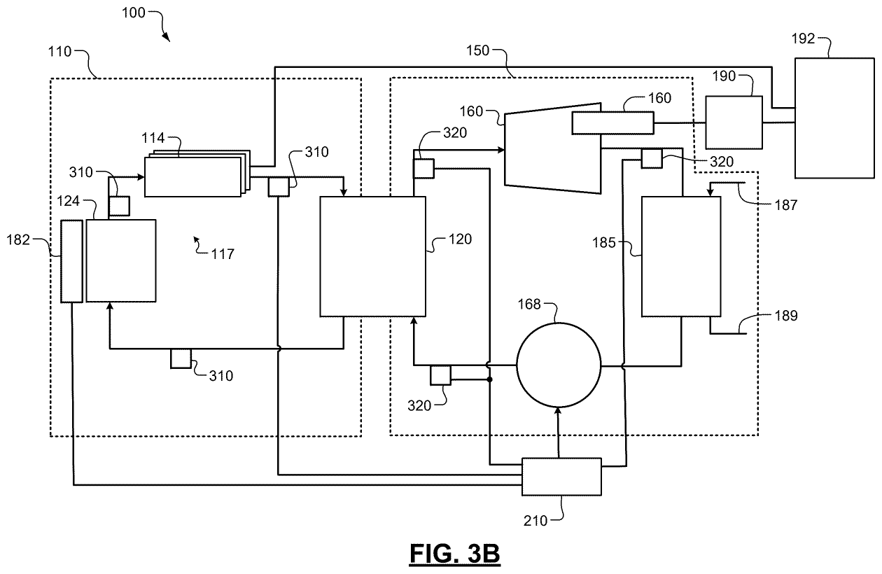

Referring now to FIGS. 3A and 3B, additional sensors can be arranged in other locations. For example, sensors 310 can be arranged between one or more of the components of the fuel cell system 110. Likewise, sensors 320 can be arranged between one or more of the components of the waste heat recovery system 150. In some examples, the sensors 310 and 320 are selected from a group consisting of pressure sensors, temperature sensors, flow rate sensors, and/or combinations thereof. Different sensors or combinations of sensors can be used between the different components.

In FIG. 3A, the condenser 164 causes the working fluid to exchange heat with gas such as air. In FIG. 3B, a condenser 185 causes the working fluid to exchange heat with a liquid.

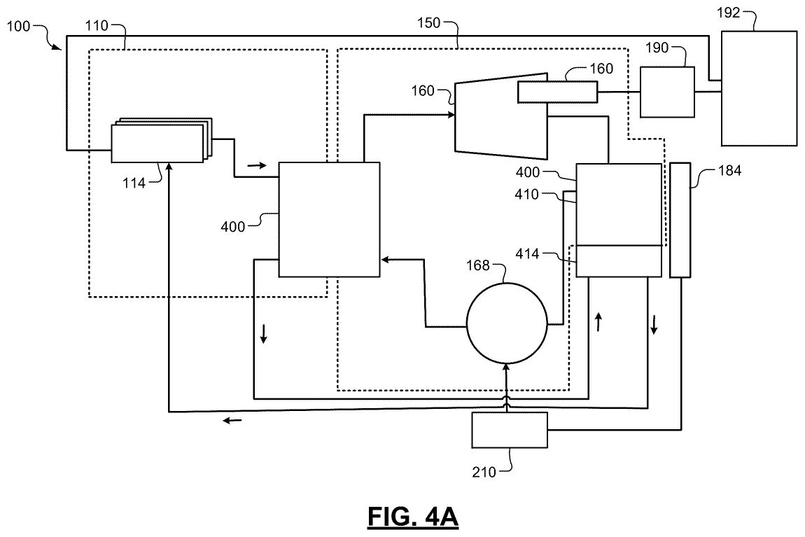

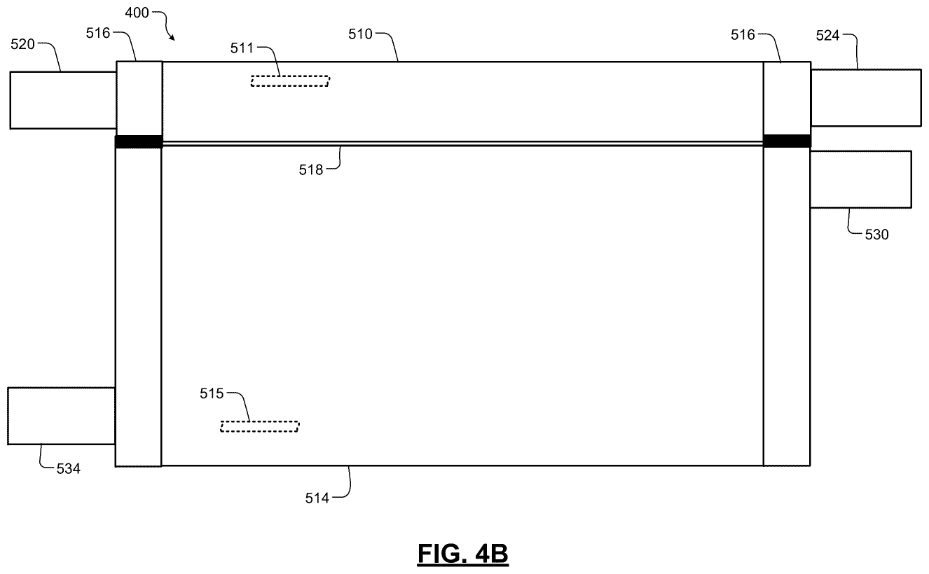

Referring now to FIG. 4A, a combined condenser/radiator 400 can be used instead of the condenser and the radiator to reduce packaging size. The combined condenser/radiator 400 includes a condenser portion 410 and a radiator portion 414. The condenser portion 410 exchanges heat between the working fluid and air. The radiator portion 414 exchanges heat between the liquid coolant and air.

Referring now to FIG. 4B, an example of the combined condenser/radiator 400 is shown to include a radiator portion 510 and a condenser portion 514 arranged between opposite support members such as walls 516. A separating wall 518 separates the radiator portion 510 and the condenser portion 514. In some examples, the separating wall 518 is made of a thermally insulating material.

The radiator portion 510 exchanges heat from the liquid coolant to air and can have any suitable radiator structure. In some examples, the radiator portion 510 includes tubing 511 or one or more sets of facing plates (sealed by gaskets) including an inlet and an outlet, a liquid channel or cavity, and cooling fins in contact with air and liquid coolant. In some examples, the condenser portion 514 includes tubing 515 or one or more sets of facing plates (sealed by gaskets) including an inlet and an outlet, a liquid channel or cavity, and cooling fins in contact with air and liquid coolant.

In some examples, coolant from the FCS is fed to an inlet 520 of the radiator portion 510. Coolant at an outlet 524 of the radiator portion 510 is fed back to the FCS. Working fluid from the turbine 160 is fed to an inlet 530 of the condenser portion 514. Working fluid at an outlet 534 of from the condenser portion 514, respectively, is fed back to the pump 168. The radiator portion 510 exchanges heat between the liquid coolant and air. The condenser portion 514 in exchanges heat between the working fluid and air.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is

1. A fuel cell system, comprising:
F fuel cell stacks, where F is an integer greater than or equal to one;
a coolant system including liquid coolant in fluid communication with the F fuel cell stacks;
a waste heat recovery system comprising:
a turbine;
a generator rotated by the turbine;
a condenser in fluid communication with an outlet of the turbine; and
a pump fluidly coupled to an outlet of the condenser; and
a heat exchanger in fluid communication with the coolant system, an inlet of the turbine and an outlet of the pump and configured to exchange heat between the liquid coolant and a working fluid to expand the working fluid supplied to the inlet of the turbine.

2. The fuel cell system of claim 1, further comprising a sensor configured to sense an operating parameter of the working fluid.

3. The fuel cell system of claim 2, further comprising a controller configured to control the pump to adjust a flow rate of the working fluid flowing through the heat exchanger in response to the sensed operating parameter.

4. The fuel cell system of claim 2, wherein the operating parameter is selected from a group consisting of temperature, pressure, flow rate, and combinations thereof.

5. The fuel cell system of claim 2, wherein the operating parameter is sensed between at least one of the turbine and the heat exchanger, the turbine and the condenser, the condenser and the pump, and the pump and the heat exchanger.

6. The fuel cell system of claim 1, wherein the heat exchanger includes tubing configured to receive the working fluid.

7. The fuel cell system of claim 1, wherein the condenser exchanges heat between the working fluid and air.

8. The fuel cell system of claim 1, wherein the condenser exchanges heat between the working fluid and a liquid.

9. A vehicle comprising the fuel cell system of claim 1.

10. A fuel cell system comprising:
F fuel cell stacks, where F is an integer greater than zero;
a coolant system including liquid coolant in fluid communication with the F fuel cell stacks;
a waste heat recovery system comprising:
a turbine receiving a working fluid after expansion;
a generator rotated by the turbine;
a pump; and
a heat exchanger in fluid communication with the coolant system, an inlet of the turbine and an outlet of the pump and configured to exchange heat between the liquid coolant and a working fluid to expand the working fluid supplied to the inlet of the turbine; and
a condenser/radiator including:
a radiator portion configured to receive liquid coolant from the coolant system and to exchange heat between the liquid coolant and a first fluid;
a condenser portion configured to exchange heat between the working fluid from the waste heat recovery system and a second fluid; and
a separating wall arranged between the radiator portion and the condenser portion.

11. The fuel cell system of claim 10, wherein the second fluid includes air.

12. The fuel cell system of claim 10, wherein the second fluid includes a liquid.

13. The fuel cell system of claim 10, wherein the radiator portion includes first tubing configured to receive the liquid coolant.

14. The fuel cell system of claim 10, wherein the condenser portion includes second tubing configured to receive the working fluid.

15. The fuel cell system of claim 10, further comprising a sensor configured to sense an operating parameter of the working fluid.

16. The fuel cell system of claim 15, further comprising a controller configured to adjust a flow rate of the working fluid flowing through the condenser portion in response to the sensed operating parameter.

17. The fuel cell system of claim 16, wherein the operating parameter is selected from a group consisting of temperature, pressure, flow rate, and combinations thereof.

18. The fuel cell system of claim 16, wherein the operating parameter is sensed between at least one of the turbine and the heat exchanger, the turbine and the condenser portion, the condenser portion and the pump, and the pump and the heat exchanger.

19. A vehicle comprising the fuel cell system of claim 10.
